(19) United States
(12) Patent Application Publication
(10) Pub. No.: US 2007/0082179 A1
(43) Pub. Date: Apr. 12, 2007

(54) Method and apparatus for forming optical articles

(76) Inventors: James J. Wade, (US); Bradley J. Sissom, (US); Benjamin C. Ihas, Boulder, CO (US); Mark D. Michaels, Colorado Springs, CO (US); Michael Tackitt, Lyons, CO (US); Brian Riley, (US); Lisa Dhar, Broomfield, CO (US); Kevin R. Curtis, Longmont, CO (US)

Correspondence Address: MORRISON & FOERSTER LLP, 755 PAGE MILL RD, PALO ALTO, CA, 94304-1018, US

(21) Appl. No.: 11/245,911

(22) Filed: Oct. 7, 2005

(51) Int. Cl. B32B 1/00

(52) U.S. Cl. 428/174

(57) ABSTRACT

A method and apparatus for fabricating a multi-layer optical article includes grasping an outer surface of a first substrate with a first holder, whereby the outer surface of the first substrate is held to an inner surface of the first holder, grasping an outer surface of a second substrate with a second holder, whereby the outer surface of the second substrate is held to an inner surface of the second holder, arranging the inner surfaces of the holders to face one another, arranging at least one spacer element between the holders, disposing an adherent on the inner surface of one of the substrates, moving the holders together such that the holders contact the at least one spacer and the substrates contact the adherent, and at least partially curing the adherent while the inner surfaces of the holders are in a selected angular relationship.

### TECHNICAL FIELD

The present invention relates generally to multi-layer optical articles, and more specifically to improved methods and apparatuses for forming multi-layer optical articles with improved optical properties.

### BACKGROUND

Many optical systems require devices having specific optical properties, in particular, surface flatness, thickness uniformity, and/or bow. Surface flatness of an article is determined by measuring the variation of the article's surface from a specified surface profile (the profile, for example, may have a certain bow). The thickness uniformity is measured by the article's variation from a specified thickness or profile (e.g., parallel or wedge-shaped). Both of these parameters are typically measured in units of optical waves of variation from the specified profile per transverse distance, e.g., waves/cm, where the wave is a specified wavelength, e.g., of the particular light being used for measurement or for the ultimate use. When used herein, units of waves/cm indicate an average measurement over the area of the article intended to have the desired optical characteristics. Bow is a physical measurement, determined as shown by FIG. 1a. The distance B from the center of an article to a line drawn between two contact points where a plane meets the article is divided by half of the distance Y of that line. The units (e.g., B cm/(Y/2) cm) divide out to give a unitless value. Methods for forming optical articles are discussed in U.S. Pat. No. 5,932,045, entitled “Methods for Fabricating a Multi-layer Optical Article,” and U.S. Pat. No. 6,156,415 entitled “Method for Fabricating a Multi-layer Optical Article and a System Having a Multi-layer Optical Article,” both of which are incorporated herein by reference.

For optics applications, where one is concerned with the effect of an article on light passing through that article, physical thickness uniformity is typically not relied upon. Instead, a directly related to transmission flatness is determined by measuring the deviation of the optical path length (discussed below) from the preselected profile, and FIG. 1b shows this measurement for a configuration desired to have a uniform thickness (i.e., parallel surfaces). Transmission flatness is also presented in waves/cm, and, as known to those in the art, transmission flatness may also be expressed in rms (root mean squared) waves/cm or by the Strehl value, as discussed in J. W. Goodman, Introduction to Fourier Optics, McGraw-Hill, 1968. FIG. 1b shows two paths through a multi-layer article, the paths located a distance z from each other transversely across the article. The physical path length difference across distance z is |1′−1|, and the variation from exact thickness uniformity is |1′−1|/z, which is typically measured in micrometers/cm. The physical path length is not affected by, nor does it take into account, the refractive indices of the individual layers 10, 12, and 14, or the wavelength of the light being used.

Optical path length (OPL) is the relevant parameter for transmission flatness and is represented by the following formula:

$$OPL = {\sum }_{j} n jLj ,$$

where

nⱼ is the refractive index of layer j and

Lⱼ is the physical path length through layer j.

In contrast to physical path length, the OPL depends on the refractive index. For example, in a multi-layer article such as that of FIG. 1b, the OPL depends on the refractive indices of layers 10, 12, and 14. Specifically, the OPL difference (ΔOPL) across the article of FIG. 1b is equal to:
|(n₁₀L₁₀+n₁₂L₁₂+n₁₄L₁₄)−(n₁₀L′₁₀+n₁₂L′₁₂+n₁₄L′₁₄)|

This equation shows that where the goal is a small OPL difference, if the substrates have relatively large individual thickness variations, but the overall thickness variation is relatively small, it is useful for the refractive indices of the substrates to be close. As reflected in FIG. 1B, the transmission flatness, assuming a parallel configuration is desired, is therefore ΔOPL/z. For optics applications, it is clear that the variation from a selected profile in OPL is more meaningful than the change in physical path length per transverse unit.

Transmission and surface flatness values are presented in waves/cm, where the value given is for a specified wavelength. Use of such waves/cm herein indicates that the value is for the optical path length as opposed to the physical path length. For purposes of the present application, values in waves/cm are useful at least for wavelengths ranging from about 0.3 to about 0.9 micrometers, but the concept of the invention extends beyond this range.

For substrates typically used in optics applications, there are three basic types of thickness variations that affect surface and transmission flatness. The first type is a linear thickness change from low to high over the surface of the substrate, whereby the substrate essentially takes the form of a wedge. The thickness variation of such a substrate per unit length is relatively constant. The second type of a variation is a gradual, wavy, or random, variation, where the thickness varies, for example, from low to high to low to high gradually across the width of the substrate. The thickness variation of such a substrate per unit length is relatively constant, but the substrate does not take the form of a wedge. The third type of variation is localized, sharp divots or peaks. Such divots or peaks typically cause rapid variations in thickness measurements taken at different locations along a substrate and may therefore skew an rms measurement. Structures having this third type of variation are typically measured in terms of scratch and dig, as known in the art. Clearly, these characteristics often cause numerous difficulties when attempting to form structures with combinations of low surface smoothness variations, low thickness uniformity variations, and/or low bow.

Articles used in precise applications desirably have a surface and transmission flatness of 0.1 waves/cm or better. Articles for transmission applications where parallel surfaces are desired desirably have a bow of 10⁻² or less (less meaning numerically smaller), and articles for reflection applications where parallel surfaces are desired desirably have a bow of 10⁻⁵ or less. Optical articles can also be used as memory cells for holographic data storage systems. Memory cells for holographic data storage systems are discussed, for example, in H.-Y. Li et al., “Three-dimensional holographic disks,” Appl. Opt., 33, pp. 3764-3774 (1994), and A. Pu et al., “A new method for holographic data storage in photopolymer films,” Proceedings from IEEE/IEOS 1994 Symposium, pp. 433-435, the disclosures of which are hereby incorporated by reference. It is desirable for the memory cells to have a surface and transmission flatness of about 0.25 waves/cm or better and a bow of about 10⁻² or less.

It is difficult to prepare or obtain substrates or multi-layer articles having such properties. High quality glass intended for flat panel displays (referred to herein as display glass), for example, will have surface and transmission flatness values ranging from about 0.25 to about 4 waves/cm. To obtain better, and more consistent flatness values, it is necessary to obtain a thick piece of glass and polish the glass to a desired flatness. Such chemical/mechanical polishing, however, is expensive and time-consuming, and may still be inadequate for preparing substrates and articles having the above properties. Easier and less expensive methods for improving the optical flatness of substrates and for forming optical articles, e.g., articles, having certain bow, thickness uniformity, and surface flatness, are desired, particularly for optical articles which have already been previously formed with inadequate surface flatness, thickness uniformity, or bow.

Prior art methods and apparatuses for forming optical articles with desired surface and transmission flatness use, for example, gimbal assemblies. Referring to FIG. 2, an exemplary gimbal mount apparatus for forming optical articles is shown. An optical flat 110 is attached to a gimbal mirror mount 102 with screw drives 104. Gimbal mirror mount 102 rotates in pitch and yaw (i.e., about an x- and y-axis). An optical flat 112 is attached to a second gimbal mirror mount 106 with screw drives 108. Second gimbal mirror mount 106 may rotate in pitch and yaw (i.e., about an x- and y-axis) or be fixed, but is capable of movement along the z-axis. Attached to optical flat 110 is a vacuum line 114 connected to grooves machined into the optical flat. Gimbal mirror mount 102 and 106 each have two mutually perpendicular axes of rotations that are fixed in space. The positioning of gimbal mirror mount 102 is adjusted by screw drives 104 to provide angular adjustment of the optical flat 110. The positioning of mirror mount 106 is adjusted by screw drives 108 to provide angular adjustment of the optical flat 112. Optical flat 110 is used to hold substrate 120 and optical flat 112 is used to hold substrate 122. An adherent 118 is disposed on substrate 122 in the process used to form the optical article by subsequently bringing substrate 120 and substrate 122 together with the adherent 118.

When a parallel relationship between optical flat 110 and optical flat 112 is desired, to form an optical article with parallel surfaces, screw drives 108 and 104 are adjusted to achieve the desired relationship. Creating the parallel relationship between the optical flats 110 and 112 typically involves multiple and time-consuming adjustments and/or measurements of the apparatus. It is possible to use a Fizeau interferometric method such as discussed in E. Hecht, Optics, Addison-Wesley Publishing, 1987, or a similar method known in the art, to measure the parallelism of the inner surfaces of the optical flats 110 and 112 and allow for appropriate corrections. Several time consuming adjustments may be necessary in order to bring the optical flats into a desired parallel relationship prior to forming an optical article. Only when parallelism is established are substrates placed onto the inner surfaces of the optical flats. In addition, adjustments may be needed periodically during production of a lot or batch of optical articles. For example, the precise parallel relationship of the optical flats may drift over time. The down time of the apparatus required to measure and adjust the optical flats to the desired parallel relationship increases the cost and time of production.

### SUMMARY OF THE INVENTION

In one exemplary embodiment, a method for fabricating a multi-layer optical article is provided. The method includes grasping an outer surface of a first substrate with a first holder, whereby the outer surface of the first substrate is held to an inner surface of the first holder, grasping an outer surface of a second substrate with a second holder, whereby the outer surface of the second substrate is held to an inner surface of the second holder. The method may further include arranging the inner surfaces of the first and second holders to face one another, arranging at least one spacer element between the first and second holders, disposing an adherent on the inner surface of the first or second substrate, moving the first and second holders toward each other such that the first and second holders contact the at least one spacer element, and at least partially curing the adherent while the inner surfaces of the first and second holders are in a selected angular relationship to form a multi-layer article. After removal of the first and second holder the at least partially cured adherent maintains the multi-layer article in a posture at which the first and second holders held the multi-layer article.

For example, the above-described embodiment may further include any of the following.

The first and second holders may be positioned facing each other at a selected angular relationship after contacting the at least one spacer. The selected angular relationship may be a parallel relationship. The first and second holders may also be positioned facing each other at a selected angular relationship prior to moving the first and second holders toward each other. The selected angular relationship may be a parallel relationship.

The at least one spacer element may determine the thickness of the multi-layer optical article. The at least one spacer element may include a spacer ball, spacer ring, static mount, or other mechanical means for holding a precise distance between the inner surface of the first holder and the inner surface of the second holder. A mechanical mount may be used to position the at least one spacer element between the inner surface of the first holder and the inner surface of the second holder. The at least one spacer element may be mechanically coupled to at least the inner surface of the first holder or the inner surface of the second holder.

The inner surface of the first holder and the inner surface of the second holder may be optically flat. The first holder and second holder may be hinged to contact the at least one spacer element. The first holder may have a first hole at the first holder center and the second holder may have a second hole at the second holder center, wherein the first hole is aligned with the second hole by a cylinder inserted into the hole of at least the first or second holder.

Disposing an adherent may include drawing in via capillary action an adherent. Disposing an adherent may also include injecting, extruding, pouring, pipetting, roll coating, blade coating, or spraying an adherent. Disposing an adherent on the inner surface of the first substrate or the inner surface of the second substrate may include dispensing the adherent through a hole in the first or second substrate via a corresponding hole in the first or second holder.

The outer surface of a substrate may be held to an inner surface of a holder using a vacuum force, an electromagnetic force, or the like.

The holders may be transparent plates. The holders may be made of a material including glass, ceramic, or the like. The holders may include at least one vacuum groove therein for applying a vacuum force to a substrate. The holders may have at least one hole for dispensing an adherent through the holder.

The substrates may be made from glass, silicon, polycarbonate, polymethyl methacrylate, acrylic, or any combination thereof. The substrates may comprise at least one hole for dispensing an adherent through the substrate. The geometric form of the substrates may be square, rectangular, circular, or oval. The substrates may be about 25 micrometers to about 3 millimeters in thickness. The outer surface of the first or second substrates may contain surface relief patterns. The inner surface of the first or second substrate may contain a surface relief pattern or a diffractive grating. The first or second substrate may be an optical article. The optical article may be a polarizer, half wave plate, quarter wave plate, or neutral density filter.

The method may further comprise the step of cleaning the inner or outer surface of the first or second substrate before grasping by the first or second holder. The step of cleaning may include applying a cleaning solvent to the surface of the substrate and evaporating the solvent by spinning the substrate.

The multi-layer optical article may have an average surface flatness of about 0.05 waves/cm to about 1 wave/cm at wavelengths of, for example, about 300 nanometers to 1600 nanometers. The article may have an average transmission flatness of about 0.05 waves/cm to about 1 wave/cm at wavelengths, for example, of about 300 nanometers to 1600 nanometers. The article may have a bow of approximately 10⁻², 10⁻⁵, or less. The multi-layer optical article may have a Strehl value of 0.9 or greater.

The adherent may be applied in a continuous layer. The adherent may include a photocurable adherent. The adherent may have a refractive index within one percent of the average refractive indices of the first substrate and the second substrate. The adherent may be cured utilizing thermal or radiation energy. The use of heat may be used to accelerate curing of the adherent.

The multi-layer article may be released from the holders by injecting a gas into the holder vacuum grooves.

In another exemplary embodiment, an apparatus for forming a multi-layer article includes a first holder and a second holder where at least one spacer element may be positioned between the first holder and second holder. At least one of the first holder and second holder may be movable along an axis, and at least one of the first holder and second holder may be rotatable or hingable. A means for moving the at least one of the first holder and second holder along an axis may be included such that the first holder and second holder come together to contact the spacer element. Further, the first and second holders may include an inner surface being optically flat, at least one vacuum groove formed therein. The spacer element may further create a parallel relationship between the first and second holders, and may include spacer balls, spacer rings, or other mechanical means for creating a precise distance between the first and second holders.

Further, the above-described embodiment may include any of the following.

The first and second holders may be positioned facing each other at a selected angular relationship after contacting the at least one spacer. The selected angular relationship may be a parallel relationship. The first and second holders may also be positioned facing each other at a selected angular relationship prior to contacting the at least one spacer element. The selected angular relationship may be a parallel relationship.

The at least one spacer element may determine the thickness of the multi-layer optical article. The at least one spacer element may include a spacer ball, spacer ring, static mount, or other mechanical means. for holding a precise distance between the inner surface of the first holder and the inner surface of the second holder. A mechanical mount may be used to position the at least one spacer element between the inner surface of the first holder and the inner surface of the second holder. The at least one spacer element may be mechanically coupled to at least the inner surface of the first holder or the inner surface of the second holder.

The inner surface of the first holder and the inner surface of the second holder may be optically flat. The first holder and second holder may be hinged to contact the at least one spacer element. The first holder may have a first hole at the first holder center and the second holder may have a second hole at the second holder center, wherein the first hole is aligned with the second hole by a cylinder inserted into the hole of at least the first or second holder.

In another exemplary embodiment, a system comprising a multi-layer article that includes a substrate and a layer of at least partially cured adherent adhered to the substrate, wherein the multi-layer article has surface flatness and transmission flatness values of about 0.05 to about 0.25 waves/cm, and wherein the force exerted by the adherent on the substrate maintains the flatness.

Still other exemplary methods and apparatuses of the present invention will become apparent to those skilled in the art from the following detailed description, wherein is shown and described only the embodiments of the invention by way of illustration of the best modes contemplated for carrying out the invention. As will be realized, the invention is capable of modification in various obvious aspects, all without departing from the spirit and scope of the present invention. Accordingly, the drawings and detailed description are to be regarded as illustrative in nature and not restrictive.

### DESCRIPTION OF THE DRAWINGS

The features and advantages of the systems and methods of the present invention will be apparent from the following description in which:

FIG. 1a illustrates bow in an optical article.

FIG. 1b illustrates physical and optical path length through a multi-layer optical article.

FIG. 2 illustrates an exemplary gimbal mount apparatus for forming multi-layer optical articles.

FIG. 3 illustrates an exemplary embodiment of an apparatus to form a multi-layer optical article.

FIG. 4a shows an inner surface of a holder of an exemplary apparatus to form a multi-layer optical article.

FIG. 4b shows a cross-sectional side view, along line a-a′, of the exemplary apparatus to form a multi-layer optical article of FIG. 4a.

FIG. 5a shows the inner surface of a holder of another exemplary apparatus to form a multi-layer optical article.

FIG. 5b shows a cross-sectional side view, along line b-b′, of the exemplary apparatus to form a multi-layer optical article of FIG. 5a.

FIGS. 6a-6d show a detailed view of an exemplary process to form a multi-layer optical article.

FIGS. 7 and 8 illustrate the forces required to maintain the optical characteristics of exemplary multi-layer optical articles.

FIGS. 9 and 10 illustrate data obtained from multi-layer optical articles using a ZYGO interferometer.

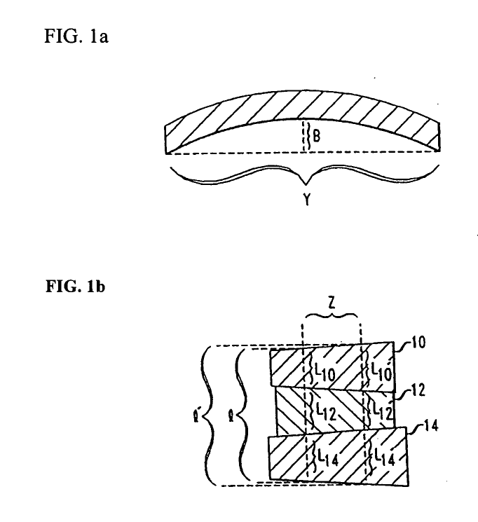

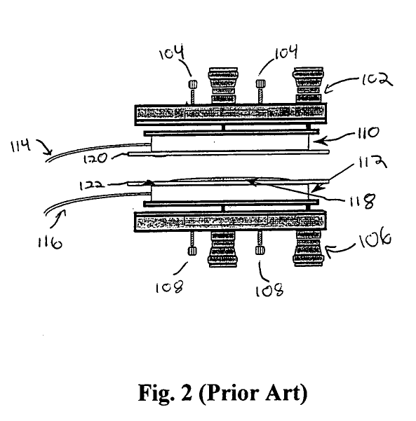

### DETAILED DESCRIPTION

Broadly speaking, methods of fabrication of multi-layer optical articles are provided. In particular, an optical article of desired optical flatness with the benefits of an improved thickness resolution and non-optical means of fabrication is provided. Previous methods require interferometric, or other means, of observing a desired angular relationship. Further, other parameters of the article are measured with less accuracy, such as the article's thickness. Using a precision spacer between inner surfaces of first and second holders of an apparatus for forming multi-layer optical articles, an optically flat article with improved thickness resolution and non-optical means of fabrication is achieved. The precision spacer(s) are, for example, spacer balls, spacer rings, static mounts, and the like that mechanically hold a precise thickness of the optical article between the first and second holders. The precision spacers also position the holders into a desired angular relationship, for example, parallel.

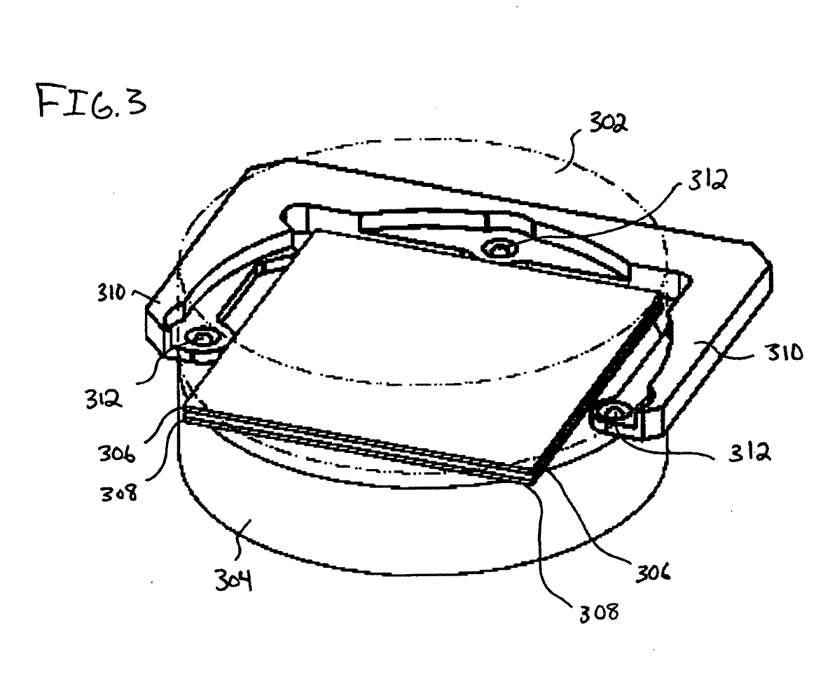

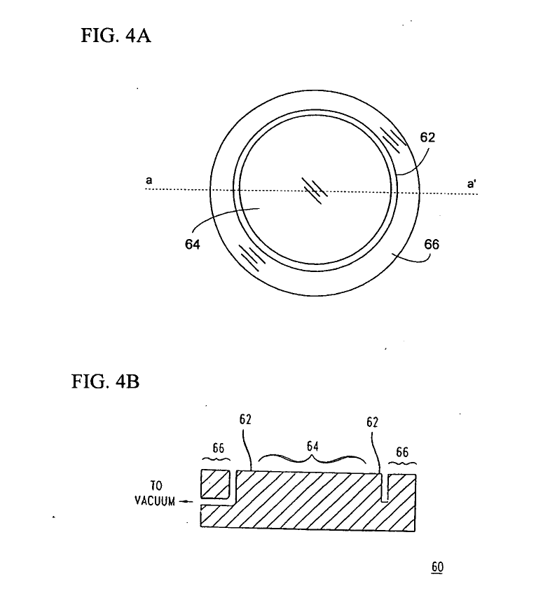

Referring to FIG. 3, an elevated view of an exemplary apparatus 300 for forming optical multi-layer articles is shown. A brief description of exemplary apparatus 300 will be described with reference to FIG. 3 followed by a more detailed description of exemplary embodiments and methods with reference to FIGS. 4 through 10. The exemplary apparatus 300 includes a first holder 302, and a second holder 304 for holding substrates 306 and 308, often referred to as optical flats. (Note in FIG. 3 that holder 302 is outlined to allow viewing of structure positioned below, however, holder 302 may or may not be transparent in actual use.) Holders 302 and 304 are, for example, cylindrical shaped disks controlled by a mechanical arm, holder, or other positioning means such that holders 302 and 304 are movable in an up or down position, i.e., about a z-axis, as well as being able to hinge or rotate in pitch and yaw, i.e., about an x- and y-axis. Holders 302 and 304 are illustrated as circles and substrates 306 and 308 are illustrated as square plates, in part, for illustrative purposes. It should be recognized that other shapes may be used for holders 302 and 304 and substrates 306 and 308 depending on the particular application.

A mechanical mount 310 is further provided with exemplary apparatus 300. Mechanical mount 310 is configured to engage and/or hold the edge of at least one of the substrates 306 or 308, and to hold and position at least one precision spacer element, such as spacer balls 312, around substrate 306 and 308, and between holders 302 and 304. Mechanical mount 310 is optional, and other means for placing and arranging spacer elements are possible. Spacer balls 312 are, for example, Anti-Friction Bearing Manufacturers Association (AFBMA) Grade 25 standard made of a single crystal sapphire with a diameter of 3.000 mm. Other precision spacers elements include spacer rings, static mounts, and other means of mechanically holding a precise thickness between holders 302 and 304 when they are brought together. Spacer balls 312 are positioned such that when the top and bottom holders 302 and 304 are brought together to adhere substrates 306 and 308 together, the holders 302 and 304 are positioned in a parallel relationship with each other to form a precise thickness optical article. This is achieved in part by allowing one or both of the holders 302 and 304 to be hinged and allowed to rotate about the x- and y-axis. Thus, as the holders 302 and 304 are brought together, if they are not in a substantially parallel relationship, one or more of the spacer balls will contact the opposing holder 302 or 304 first. One or both of the holders 302 and 304 will then hinge or rotate as the holders 302 and 304 are brought together to contact the remaining spacer balls 312. This process thereby positions holders 302 and 304 in a desired angular relationship, for example a parallel relationship, with a precise thickness defined by the diameter or thickness of spacer balls 312.

Prior to bringing the holder 302 and 304 together, matrix resin 307 may be pooled on the lower substrate 308. As the movement of the holder 302 or 304 brings the substrates 306 and 308 towards each other the substrates contact the matrix resin 307. The apparatus can then be left with the holders in a desired angular relationship until the matrix resin 307 has at least partially hardened.

The parallel relationship between optical flats 302 and 304 is determined and maintained by the presence of the spacer balls 312. By a parallel relationship, it is meant that the distance between the continuous surface portions of the inner surfaces of the two holders, i.e., the optical flats, does not vary by more than about 1 wave/cm. A multi-layer article having parallel substrates preferably has surface flatness and transmission flatness values of about 0.05 to about 1 waves/cm. Additionally, a Strehl value of 0.5 or greater, and more advantageously 0.9 or greater is desirable. A bow of about 10⁻² or less is also advantageous. It should be recognized, however, that by using different sized spacer elements optical articles with non-parallel surfaces may be created.

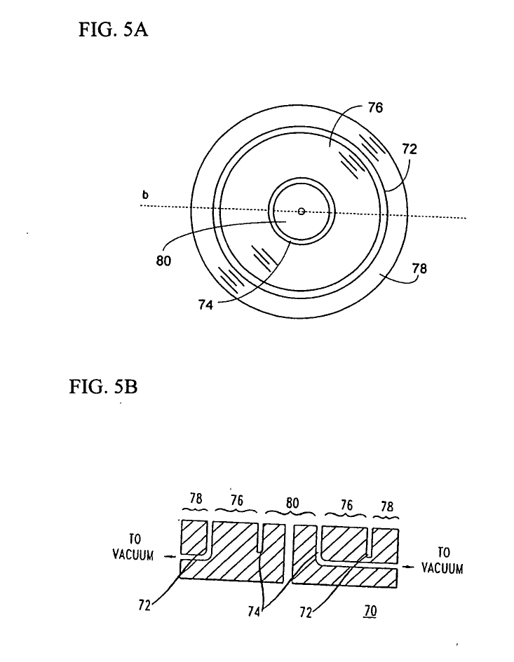

To maintain the surface flatness, transmission flatness, and/or bow, the inner surface of the holder or holders include a continuous surface portion to which at least a portion of the substrate substantially conforms. As used herein, the term holder is intended to define an article comprising, among other things, such a continuous surface portion. The continuous surface portion is desirably free of a discontinuity that would allow for non-conformance of the substrate. (It is possible for the continuous surface portion to have relatively small discontinuities, e.g., small holes, as long as the discontinuities do not allow for such non-conformance.) It is possible for the continuous surface portion to be bounded by an area where a grasping force is applied, e.g., a vacuum groove (such as in FIGS. 4a and 4b below), or for the grasping force to be applied at more than one area around and/or within the continuous surface portion, e.g., several vacuum grooves (such as in FIGS. 5a and 5b below) or several vacuum holes. It is also possible for the grasping force to be applied through the entire continuous surface portion, e.g., by an electromagnetic material. It is over this continuous surface portion that the flatness and/or bow are maintained.

The spacer elements may also be used with other exemplary methods and apparatus such as those disclosed in U.S. patent application Ser. No. 09/935,462 entitled “Method and Apparatus for Multi-layer Optical Articles” filed on Aug. 22, 2001 and U.S. patent application Ser. No. 10/043,939 entitled “Method and Apparatus for an Encased Optical Article” filed on Jan. 11, 2002, both of which are incorporated herein by reference. Therefore, exemplary spacer elements may be used with various methods and apparatus that rely upon other means to create a parallel relationship between the holders and serve primarily to create a precise thickness optical article.

FIGS. 4a and 4b show a holder 60 suitable for use in the invention that contains such a continuous surface portion. (FIG. 4b is a cross-sectional side view along line a-a′ of FIG. 4a.) The holder 60 contains a single vacuum groove 62 that is attached to a vacuum (not shown). The vacuum groove 62 bounds a continuous surface 64 to which a substrate will substantially conform upon application of the vacuum. Surface 66 of the holder 60 is outside the vacuum groove 62, and is not part of a continuous surface portion. A substrate would not be forced to substantially comply with the surface 66 upon application of a vacuum.

FIGS. 5a and 5b show another holder 70 suitable for use in the invention. (FIG. 5b is a cross-sectional side view along line b-b′ of FIG. 5a.) The holder 70 contains two vacuum grooves-an outer vacuum groove 72 and an inner vacuum groove 74. A continuous surface 76 lies between groove 72 and groove 74. Surface 78 (lying outside the outer vacuum groove 72) is not part of a continuous surface portion. Also, as shown in FIGS. 5a and 5b, it is possible for holder 70 to have a hole 82 located at the area of surface 80, in which case surface 80 is also not part of a continuous surface portion. Holder 70, with hole 82 formed therein, can be advantageously used with the apparatus to aid in aligning the top and bottom holders and consequently top and bottom substrates. For example, a cylinder or rod can be positioned through hole 82 of the top and bottom holder 70 and substrates such that the holders are centered with respect to each other as they are brought together.

In a case where the holder uses electromagnetic force to grasp a substrate, it is possible for the continuous surface portion to apply the force over its entirety, or for the continuous surface portion to have a particular area around its periphery, e.g., in the shape of a ring or a square, in which the force is applied. In the latter example, the posture of the substrate will be maintained over and within the ring or square in which the force is applied.

The inner surfaces of the exemplary holders have an optically desirable shape and/or surface. Advantageously, the inner surface of a holder has a surface flatness of about 0.05 to about 1 waves/cm or better. Also advantageously, the inner surface of a holder has a bow of about 10⁻² or better, particularly for articles intended for transmission applications, whereas a bow of about 10⁻⁵ or better is advantageous for articles intended for reflective applications.

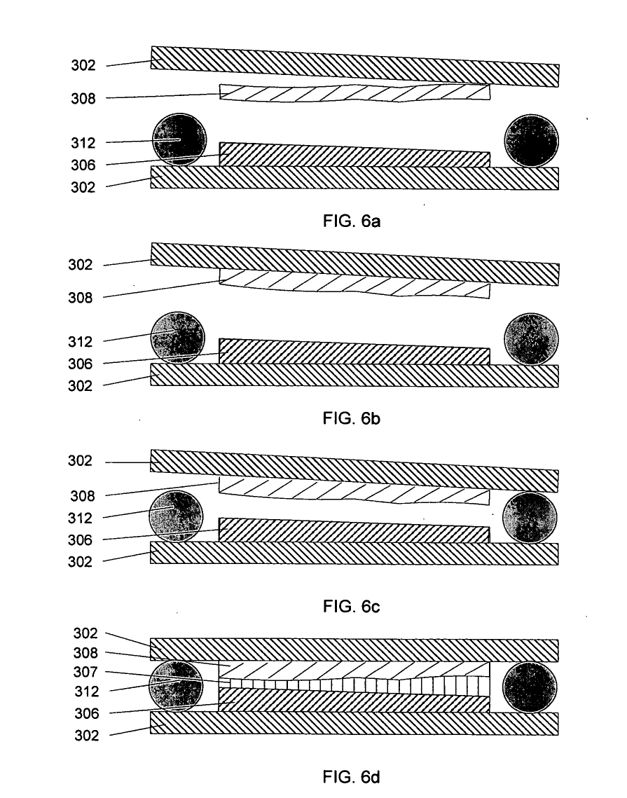

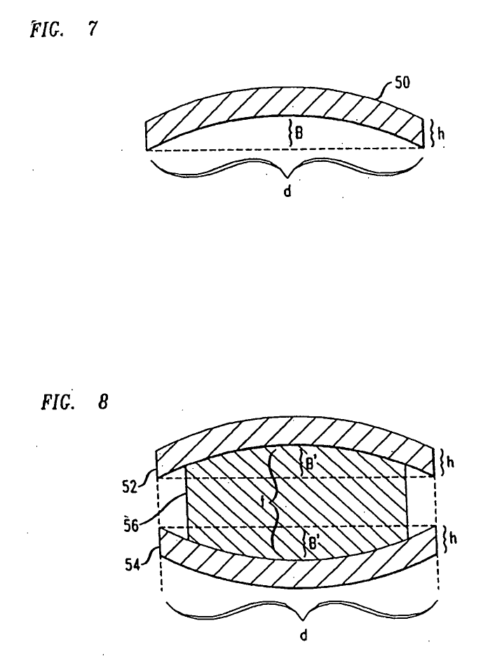

With reference now to FIGS. 6a through 6d, an exemplary method for forming a multi-layer optical article is described. FIG. 6a illustrates holders 302, 304 and substrates 306, 308 before the substrates 306, 308 are held to the surfaces of the holders 302, 304. Substrate 308 is shown with gradual, wavy thickness variations, and substrate 306 is shown with a wedge type variation. Included are spacer elements, in this example, spacer elements 312. Spacer elements can be located near either substrate 306 or 308, for example, attached to holder 302 or 304, so long as spacer elements 312 are positioned to create a precise thickness between the inner surfaces of holder 302, 304. Further, holders 302, 304 are shown facing each other in a non-parallel relationship to illustrate how spacer elements, in addition to forming a precise thickness, also form a desired angular relationship.

As shown in FIG. 6b, a force or attraction causes the outer surfaces of the substrates 306, 308 to substantially comply to the continuous surface portions (not shown) of the holders 302, 304. It is possible for the outer surfaces of the substrates 306, 308 to be held by vacuum, by electrostatic or magnetic attraction, or by a temporary chemical bond such as an adhesive. In certain cases where a temporary bond or electrostatic attraction are used, such as where thin, flexible substrates are used, the substrates 306, 308 will have to be pressed upon the holders 302, 304 in a manner that provides compliance to the surfaces of the holders 302, 304. One such manner is the use of a roller. There is no need to use the Fizeau or similar method to confirm the parallelism of the inner surfaces of the holders 302, 304 because the spacer elements 312 will serve to position holder 302, 304 in a parallel relationship as described below.

As shown in FIG. 6c, as the non-parallel holders 302, 304 are brought together, top holder 302 contacts a first spacer ball 312, in this example, to the right of FIG. 6c. As the holders 302, 304 are further brought together, the top holder 302 is hinged or rotated in the x-axis and/or y-axis direction (assuming the z-axis direction is up and down) such that the top holder comes to rest in a parallel relationship with bottom holder 304 and is in contact with all of the spacer balls 312. Additionally, if the spacer element includes a single element, such as a spacer ring, the top holder 302 cones into contact with a first portion of the spacer ring and is then hinged or rotated such that the top holder 302 fully contacts the spacer ring and is positioned in a parallel, or other desired angular, relationship.

FIG. 6d illustrates the optical article and apparatus after the holder 302, 304 are in contact with all of the spacer elements 312. The holders 302, 304 should press the substrates 306, 308 together with enough force to obtain a desired spread of adherent 307 between the substrates 306, 308 and/or obtain a desired level of contact between the adherent 307 and substrates 306, 308. In this example, it is therefore unnecessary to confirm parallelism of the holders 302, 304 prior to grasping the substrates 306, 308 and pressing the substrates 306, 308 together with the adherent 307. The spacer elements 312, however, could be used in conjunction with an apparatus that does confirm parallelism to allow for a more precise method of fabricating an optical article with a desired thickness.

The adherent 307 is then at least partially cured such that when the holders 302, 304 are removed, the rigidity or force exerted on the inner surfaces of the substrates 306, 308 by the adherent 307 maintains the substantially parallel relationship (i.e., the low bow) and the surface and transmission flatness imparted to the outer surfaces of the substrates 306, 308. The bow and flatness are maintained within the area of the continuous surface portions of the holders 306, 308, and primarily in the area contacted by the adherent 307, as discussed above. The forces involved in maintaining this relationship are discussed below.

It should be recognized that it is possible for the exemplary process illustrated in FIGS. 6a through 6d to be performed in an order other than the order presented above. Further, other configurations of the apparatus are possible, such as placing the spacer balls on the top holder 302, or on a separate mount located between the holders 302, 304. Additionally, lifting the bottom holder 304 towards the top holder 302 and hinging the bottom holder 304 to obtain the desired angular relationship can carry out the process.

The process depicted in FIGS. 6a through 6d may also be repeated to create optical articles with three or more layers. For example, after the optical article is made in FIG. 6d, the process can be repeated by grasping the optical article with the bottom holder 304 and grasping a third substrate with the top holder 302. The process in FIGS. 6a through 6d can then be repeated. Additionally, a second set of spacer elements can be used to form the multi-layer optical article at an increased thickness.

The optical article may further include a reflective layer such as in a holographic memory cell. An exemplary process of a holographic memory cell is described, for example in U.S. patent application Ser. No. 10/043,939 entitled “Method and Apparatus for an Encased Optical Article” filed on Jan. 11, 2002, and an exemplary holographic memory storage system for use with such optical articles is described in U.S. patent application Ser. No. 10/056,746 entitled “System of Holographic Storage” filed on Jan. 24, 2002, both of which are incorporated herein by reference in their entirety.

Advantageously, the multi-layer articles fabricated using the exemplary methods and apparatuses have surface flatness and transmission flatness values of about 0.05 to about 1 waves/cm, these properties are useful for at least wavelengths of about 0.3 to about 1.6 μm, although the concept of the invention extends beyond this range. Also advantageously, the articles have a bow of about 10⁻² or less, and more advantageously, about 10⁻⁵ or less (particularly for reflective applications).

The adherent is advantageously disposed in a continuous layer. The flatness and/or bow of the substrate or multi-layer article are primarily attained in the area where the adherent contacts a substrate or substrates. The area of the adherent is typically within the area of the continuous surface portion of the holder or holders. Portions of the substrate or substrates that extend past the area of the adherent, and especially past the area of the continuous surface portion tend to return to their initial state after the holder or holders are removed. When flatness, Strehl value, and bow of a substrate or an article are discussed herein, the flatness, Strehl value, or bow referred to is of this area where the adherent maintains the flatness and/or bow of a substrate or the flatness and/or bow of a multi-layer article.

The exemplary methods of the present invention are advantageously performed in a clean room environment. Among other things, a clean room helps prevent contaminants such as dust particles from lodging between the holders, substrates, and/or adherent. With thickness variations measured in wavelengths, it is apparent that even a single dust particle (typically having a diameter of 1 to 10 wavelengths) affects the flatness of the overall article.

The adherent is disposed onto the substrate or substrates by any suitable method, and is used in liquid or solid form. The adherent comprises any material that sufficiently adheres and/or provides rigidity to the substrate or substrates such that the upon removal of the holders the substrate or multi-layer article is maintained in a posture at which it was held by the holder or holders.

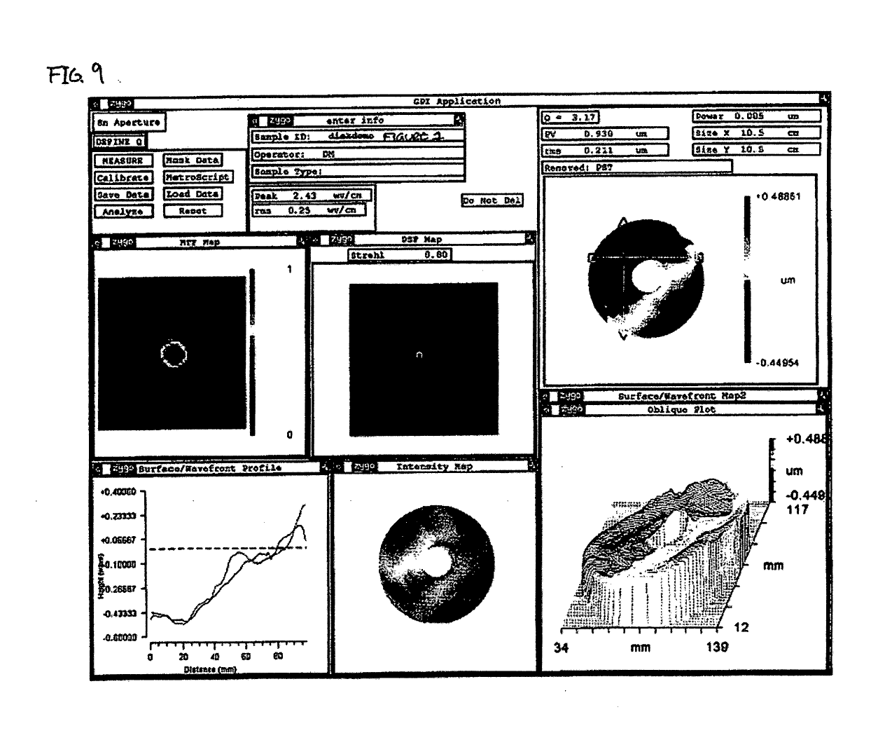

While not limiting the invention to any particular model or theory, it is believed that the following simplistic model, for both a single substrate and for two substrates can represent the force required for maintenance of the posture. See also L. D. Landau et al., Theory of Elasticity, Pergamon Press, Oxford, 3d English Ed., 1986, particularly page 44. For the equations below, the substrates are circular and initially have spherical bow, and the goal is to achieve a bow of zero. For a single substrate 50, as reflected in FIG. 7, the pressure difference across the substrate, P, necessary to produce compliance (i.e., reducing the bow to zero) is given by:

$$P = ( P 1 - P 2 ) = ( \frac{256}{3} ) ( \frac{b {h}^{3}}{{d}^{4}} ) ( \frac{E}{( 1 - {σ}^{′} ) ( 5 + {σ}^{′} )} )$$

where:

h=substrate thickness

b=height of substrate bow in center

d=diameter of substrate

P1=air pressure on free surface of substrate

P2=air pressure on vacuum flat surface of substrate

P=P1−P2=pressure difference across substrate

σ′=Poisson's ratio of substrate

E=Young's modulus of substrate

In the three-layer article of FIG. 8, there will exist a residual bow height, b′, as the substrates 52, 54 (each having an initial bow height, b, as above) attempt to return to their original form and thereby push against the adherent layer 56. Additional parameters for this model are:

b′=residual bow height in three-layer article

t=bonding layer thickness (t>>b′)

σ′=Poisson's ratio of adherent layer

E′=Young's modulus of adherent layer

For this simplified model, the ratio of the final article surface bow height to the article diameter is given by:

$$( \frac{{b}^{′}}{d} ) = ( \frac{128}{3} ) ( \frac{E}{E} ) ( \frac{b {h}^{3} t}{{d}^{5}} ) ( \frac{( 1 + {σ}^{′} ) ( 1 - 2 {σ}^{′} )}{( 1 - {σ}^{′} ) ( 1 - {σ}^{′} ) ( 5 + {σ}^{′} )} )$$

The adhesive strength between the adherent layer and the substrates thus needs to exceed the pressure differential P that is required to displace either substrate by an amount equal to (b−b′). For example, for b′<0.1 micrometers (approximately 0.2 wavelengths), d equal to 50 mm, t equal to 1 mm, E/E′ equal to 2, σ′ equal to approximately 0.25, σ′ equal to approximately zero, and h equal to 1 mm, the limit for initial substrate bow (2b/d) is less than ¼.

It is possible for the adherent to be photocurable or otherwise curable, e.g., heat or chemical curable. It is also possible for the adherent to be a material that undergoes a phase transformation, e.g., liquid to solid, to attain a required adherence. As used herein, the terms cure and curable are intended to encompass materials that gel or solidify by any such methods. Photocurable adherents include materials that cure upon exposure to any of a variety of wavelengths, including visible light, UV light, and x-rays. It is also possible to use adherents that are curable by electron or particle beams. Useful adherents include photocurable adherents that are photosensitive (referred to as photopolymers), the term photosensitive meaning a material that changes its physical and/or chemical characteristics in response to exposure to a light source (e.g., selective, localized exposure). Such photosensitive adherents include but are not limited to certain photosensitized acrylates and vinyl monomers. Photosensitive adherents are useful because they act as both an adherent and a recording media. Adherents such as those based on epoxides are also useful. One example of a useful photopolymer is an isobornyl acrylate-polytetrahydrofuran diurethane diacrylate matrix with n-vinylcarbazole dispersed therein (referred to herein as NVC).

It is possible for the adherent to comprise additives such as adherence-promoters, photoinitiators, or absorptive materials. The thickness of the post-cure adherent will vary depending on several factors, including the adherent used, the method of application, the amount of adherent applied, and force exerted on the adherent by the substrates. Different thickness will be desired for different applications. The level of cure needed is determined by the particular adherent used and by the force required to maintain a substrate or multi-layer article in the position imparted by the holder or holders. For materials that are photocurable, heat curable, or chemically curable, it is possible for suitable cures to range from a few percent to 100%. For materials that undergo a complete phase transformation, e.g., liquid to solid, to attain the needed adherence, a complete phase transformation is considered to be a complete cure for the purposes of this application.

It is advantageous for the adherent to have, after the at least partial cure, a refractive index close to that of the substrate. Having a multi-layer article with a near-uniform refractive index is advantageous because, as shown in the discussion of OPL above, a near-uniform refractive index through certain areas in an article will reduce the change in OPL in those areas. In other words, thickness variations in a substrate will not have a large effect on the ΔOPL if the adherent that fills or compensates for such variations has a refractive index close to the index of the substrate itself. For example, where two substrates each have a thickness variation of 5 waves/cm (i.e., total of 10 waves/cm), the refractive index is desirably within 1% (0.01) of the average of the refractive indices of the substrates in order to maintain a transmission flatness of 0.1 waves/cm. Where two substrates are used, the substrates advantageously have refractive indices that are equivalent to two decimal places, and the refractive index of the adherent is advantageously equivalent to two decimal places to the average of the refractive indices of the first and second substrates. In some applications, it is advantageous for the adherent to be of high optical quality, e.g., homogeneous, bubble-free, and low scattering.

The holders desirably have a continuous surface portion on their inner surfaces to which the substrate or substrates substantially comply, as discussed above. The holders are advantageously vacuum chucks, meaning a flat surface in which the inner surfaces of the holders have one or more grooves, where a grasping force is created by application of a vacuum to the substrate through the groove or grooves. Alternatively, the grasping steps are performed by use of electrostatic or magnetic attraction, or by temporary chemical bonding (e.g., adhesive). The grasping or temporary bonding force holds the substrate against the inner surface of the holder, attaining substantial compliance, particularly over the continuous surface portion of the inner surface, as discussed above. The required force will vary depending on the parameters of the particular substrates used, e.g., composition, thickness, initial flatness, flexibility. In an embodiment using two holders, the holders are arranged in any way that allows the attainment of the selected angular relationship, such as the arrangement given in the embodiment above.

It is possible for the holders to be made from any material that maintains a flat surface and is able to apply a grasping force to the substrates or adequately maintain a temporary chemical bond. In the case of a photocurable adherent, as discussed above, the holders are advantageously glass or another material that allows enough light transmission to obtain an adequate cure. In the case of adherents that do not require light to cure, it is possible to use non-transparent materials such as ceramics. The material selected for the holder also depends on the type of grasping force or temporary bond utilized, e.g., adhesive bond or magnetic attraction, and on the intended use of the multi-layer article or substrate being fabricated.

The substrates are of the same or different materials and are formed from ceramics (including glasses), metals, or plastics, depending on the intended use of the article or substrate being formed. The substrates are advantageously selected from glass, sapphire, polycarbonate, and quartz. Other materials that are transparent to the wavelength of the particular application, for example a holographic storage system, and which has adequate mechanical properties for a memory cell, may also be used as a substrate. Alternatively, substrates made from materials such as polycarbonate, polymethyl methacrylate, polyolefins, or other common plastic materials may be used.

Also, as discussed above in relation to the holders, it is possible for the substrates to be two pieces of a single part. The substrates are of any required shape. The substrates advantageously do not have flatness variations at such a high level that application of the grasping force could not attain substantial compliance with a holder surface without damaging the substrates. In addition to self-supporting substrates such as glass plates, it is possible for the substrates to be a polymeric material that is sprayed onto a holder, a thin polymer film such as Mylar®, or a polymer sheet such as polycarbonate. It is also possible for a polymeric material or film to be combined with a self-supporting material such as a glass plate to form a single substrate. The materials or films of such two-layer substrates may be photosensitive material, and the method of the invention is useful in improving the optical properties of such substrates.

The exemplary methods and apparatus make it possible to compensate for wedge type thickness variations, because the inner surfaces of the holders impart a selected angular relationship to the outer surfaces of the substrates, and wedge type variations in the substrates are translated to the interior of the article, where the adherent compensates for the variation while the angular relationship is maintained. The adherent similarly compensates for sharp or gradual wavy variations on the inner surfaces of the substrates by filling in such variations. It is possible to compensate for gradual, wavy variations on the side of the substrate on which no adherent has been disposed if (a) the method is performed such that at least some of the gradual wavy variations on the side of the substrate that complies with the holder are transmitted to the opposing side of the substrate, and (b) the adherent fills in or overlays the transmitted variations on that opposing side of the substrate. In addition, if the adherent in such a multi-layer article has a post-cure refractive index close to the refractive index of the substrate, a near-uniform refractive index will be achieved in areas containing the adherent, and the change in optical path length across these areas of the article will therefore be reduced.

As previously stated, it is possible to form memory cells for holographic data storage systems. Such cells are discussed, for example, in H.-Y. Li et al., “Three-dimensional holographic disks,” Appl. Opt., 33, pp. 3764-3774 (1994), and A. Pu et al., “A new method for holographic data storage in photopolymer films,” Proceedings from IEEE/IEOS 1994 Symposium, pp. 433-435, the disclosures of which are hereby incorporated by reference. It is also possible for cells made according to the invention to be used for digital holographic storage, in which the cells currently must have a surface and transmission flatness of about 0.25 waves/cm or better and a bow of about 10⁻² or less. An exemplary holographic memory storage system for use with such optical articles is described in U.S. patent application Ser. No. 10/056,746 entitled “System of Holographic Storage” filed on Jan. 24, 2002.

In forming a holographic memory cell, two substrates are advantageously used, and both substrates are advantageously the same material. The substrates are advantageously selected from glass, sapphire, polycarbonate, and quartz. Any other material that is transparent to the wavelength being used in the holographic storage system, and which has adequate mechanical properties for a memory cell, may also be used as a substrate. The substrates are advantageously about 0.1 to about 1 mm thick. An initial substrate will typically have surface flatness and transmission flatness values of about 0.1 to about 10 waves/cm, and a bow of about 0.1 or less. Commercially available display glass exhibits these properties, and is typically free from significant divots and peaks, meaning scratch and dig of 40/20 or better. Such display glass is suitable for fabrication of a memory cell.

As discussed above, having an adherent with a refractive index close to that of the substrates is advantageous because a near-uniform refractive index throughout a multi-layer article will reduce variations in OPL. In fabricating a holographic memory cell for digital holography, it is advantageous for the refractive index of the first substrate to be equivalent to two decimal places to the refractive index of the second substrate, and for the refractive index of the adherent to be equivalent to two decimal places to the average of the refractive indices of the first and second substrates.

It is also advantageous for the adherent in a holographic cell to be applied in a continuous layer, and for the adherent to be a photopolymer, i.e., capable of storing data in a holographic data storage system after a cure. Photopolymers such as those discussed above have been found to be useful adherents for holographic memory cells made according to the invention because these materials function both as adherents and as photosensitive recording media. After the cure, the thickness of the adherent in a memory cell is advantageously about 0.2 to about 2 mm. The post-cure memory cell advantageously has surface flatness and transmission flatness values of about 0.05 to about 0.25 waves/cm, more advantageously, about 0.05 to about 0.1 waves/cm, and a bow of about 10⁻² or less. The memory cell also advantageously has a Strehl value of about 0.9 or greater. As discussed above, these properties refer to the area of the multi-layer article within the area of the continuous surface portions of the inner surfaces of the holders, and primarily where the adherent contacts the substrates. The areas of the substrates extending past the adherent-contact area typically will not exhibit these properties.

A useful quality factor, or Q, for evaluating the properties of a memory cell made according to the method of the present invention is the Strehl value divided by the waves/cm rms transmission flatness, as measured over a predetermined area such as a 50 mm diameter circle. Advantageously, memory cells made according to the method of the present invention have a Q greater than 1, and more advantageously, greater than 4. As a comparison, display glass typically has a Q of about 0.5, window glass a Q of about 0.05. In the absence of the grasping substrates such that they substantially comply with at least the continuous surface portions of the inner surfaces of the holders, cells consisting of two substrates with adherent disposed in between would have a Q of about 0.08, primarily due to the initial Strehl of the glass, holder distortions, and shrinkage of the adherent.

The exemplary methods and apparatuses can be utilized in the fabrication of a system, e.g., an optical system, containing a multi-layer article that comprises one or two substrates and a layer of at least partially cured adherent adhered to the substrate or substrates, wherein the article has surface flatness and transmission flatness values of about 0.05 to about 0.25 waves/cm, preferably, 0.05 to about 0.1 waves/cm, and wherein the force exerted by the adherent on the substrate or substrates maintain this flatness. In some applications, primarily with two substrates, the article also has a bow of about 10⁻² or less (advantageously about 10⁻⁵ or less for reflective applications), and, in such applications, the force exerted by the adherent on the substrates maintains the bow as well. It is possible for the system to be a holographic storage system, in particular, a digital holographic data storage system. The elements of holographic storage systems are discussed, for example, in the articles cited above, as well as S. Pappu, “Holographic memories; a critical review,” Int. J. Optoelect., 5, pp. 251-292 (1990); L. Hesselink et al., “Optical memories implemented with photorefractive media,” Opt. Quant. Elect., 25, §§ 611-661 (1993); and D. Psaltis et al., “Holographic Memories,” Scientific American, November 1995, the disclosures of which are hereby incorporated by reference. The parameters of the memory cell of the holographic data storage system are as discussed above.

In addition to holographic memory cell applications, the method of the invention is useful for forming a variety of other types of articles, particularly for use in optical systems, including high quality mirrors, flats, windows, prisms, beam splitters, filters, and lenses.

The exemplary methods and apparatuses will be further clarified by the following examples, which are also intended to be purely exemplary.

### EXAMPLE I

A multi-layer optical media package was fabricated in a first example by the following steps. An optical flat was utilized with an outer diameter measuring 150 mm, a thickness of 25.4 mm, surface flatness of 0.1 waves/cm, and with etched vacuum grooves at 127 mm and 25.4 mm diameters. The vacuum grooves are about 1 mm in width and about 0.5 mm in depth. The optical flats were placed in a mechanical mount that statically held the outer rim of the optical flats flush while holding the bottom flat level. The bottom flat is then fitted with a retainer that holds 3 spacer balls at 120° increments around the outer rim. The spacer balls are AFBMA Grade 25 standard made of single crystal sapphire with a diameter of 3.000 mm. The flats were then cleaned using the drag and drop technique with methanol.

A glass substrate with an outer diameter of 130 mm, an inner hole with a diameter of 15 mm, and 0.7 mm thick was then cleaned using the same technique described above and placed concentric with the bottom optical flat. The vacuum pump was then turned on and the glass substrate was pulled compliant with the optical flat. The top flat was cleaned and mounted in the same way. Both the flats were then placed in the mechanical mount and aligned. A small cylinder measuring 15.000 mm in diameter was used to center the substrates by aligning the inner holes. The inner hole of both substrates were then masked off with a thin film to prevent any matrix resin from migrating onto the flat. The matrix resin was then pooled on the bottom substrate and the top flat was brought down slowly at an angle till surface contact with the resin was made. The top flat was then hinged slowly until it made contact with each of the spacer balls. The apparatus was then left until the matrix resin hardened or at least partially cured. The vacuum was then released and the media package was removed from the jig.

The optical media package that was obtained had a transmitted surface flatness of 0.25 waves/cm, a Strehl of 0.80, and a peak to valley wedge of 0.938 microns for a Q of 3.17. These values were obtained using a ZYGO interferometer and are shown in FIG. 9.

### EXAMPLE II

A multi-layer optical media package was fabricated by the following steps. An optical flat was utilized with an outer diameter measuring 101.6 mm, with a thickness of 25.4 mm, surface flatness of 0.1 waves/cm, with etched grooves of an inner diameter of 6.4 cm. These grooves are 3.2 mm wide by about 1.6 mm deep. Square glass substrates of display glass measuring 75 mm by 75 mm were cleaned and placed on each of the optical flats according to the method of the first example. The outer edge of the substrates and the spacer balls are held with a mechanical mount (e.g., see FIG. 3) that is incorporated with the optical flats. Matrix resin was then pooled on the bottom substrate and the top substrate was then lowered slowly an angle till surface contact was made. The top flat was then hinged slowly until it made contact with each of the spacer balls. The apparatus was then left until the matrix resin at least partially hardened. The vacuum was then released and the media package was removed from the jig.

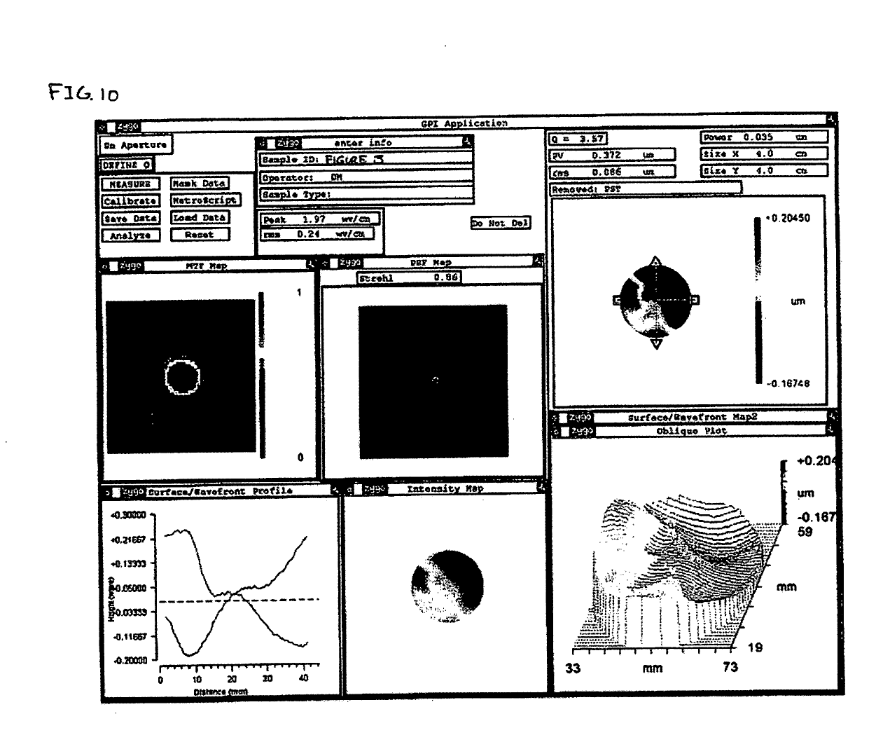

The optical media package that was obtained had a transmitted surface flatness of 0.24 waves/cm, a Strehl of 0.86, and a peak to valley wedge of 0.372 microns for a Q of 3.57. These values were obtained using a ZYGO interferometer and are shown in FIG. 10.

The above detailed description and examples are provided to illustrate exemplary embodiments and are not intended to be limiting. All publications, patents, and patent applications, are incorporated by reference herein in their entirety.

1. A method for forming a multi-layer optical article comprising:
grasping an outer surface of a first substrate with a first holder, whereby the outer surface of the first substrate is held to an inner surface of the first holder;
grasping an outer surface of a second substrate with a second holder, whereby the outer surface of the second substrate is held to an inner surface of the second holder;
arranging the inner surfaces of the first and second holders to face one another;
arranging at least one spacer element between the first and second holders;
disposing an adherent on the inner surface of the first or second substrate;
moving the first and second holders toward each other such that the first and second holders contact the at least one spacer element and the inner surfaces of the first and second substrates contact the layer of adherent; and
at least partially curing the adherent while the inner surfaces of the first and second holders are in a selected angular relationship to form a multi-layer optical article.

2. The method of claim 1, wherein the first and second holders are positioned facing each other at the selected angular relationship after contacting the at least one spacer.

3. The method of claim 1, wherein the selected angular relationship is a parallel relationship.

4. The method of claim 1, where the first and second holders are positioned facing each other at the selected angular relationship prior to moving the first and second holders toward each other.

5. The method of claim 1, wherein the at least one spacer element determines the thickness of the multi-layer optical article.

6. The method of claim 1, wherein the at least one spacer element includes a spacer ball.

7. The method of claim 1, wherein the at least one spacer element includes a spacer ring.

8. The method of claim 1, wherein the at least one spacer element includes a static mount.

9. The method of claim 1, wherein the at least one spacer element includes a mechanical means for holding a precise distance between the inner surface of the first holder and the inner surface of the second holder.

10. The method of claim 1, further comprising positioning a mechanical mount that positions the at least one spacer element between the inner surface of the first holder and the inner surface of the second holder.

11. The method of claim 1, where in the at least one spacer element is mechanically coupled to the inner surface of the first holder or the inner surface of the second holder.

12. The method of claim 1, wherein at least one of the first holder and second holder may be hinged to contact the at least one spacer element.

13. The method of claim 1, wherein the first holder has a first hole at the first holder center and the second holder has a second hole at the second holder center, wherein the first hole is aligned with the second hole by a cylinder inserted into the hole of at least the first or second holder.

14. The method of claim 1, wherein said step of disposing an adherent comprises drawing in via capillary action an adherent.

15. The method of claim 1, wherein the holders have at least one hole for dispensing an adherent through the holder.

16. The method of claim 1, wherein the adherent includes a photocurable adherent.

17. The method of claim 1, wherein the adherent has a refractive index within one percent of the average refractive indices of the first substrate and the second substrate.

18. The method of claim 1, wherein the adherent is cured utilizing thermal or radiation energy.

19. The method of claim 18, further comprising the use of heat to accelerate curing of the radiation energy.

20. The method of claim 1, wherein the multi-layer article is released from the holders by injecting a gas into the holder vacuum grooves.

21. A multi-layer optical article produced by the method of claim 1.

22. The multi-layer optical article of claim 21, wherein the multi-layer optical article has an average surface flatness of about 0.05 waves/cm to about 1 wave/cm at wavelengths of about 300 nanometers to 1600 nanometers.

23. The multi-layer optical article of claim 21, wherein the multi-layer optical article has an average transmission flatness of about 0.05 waves/cm to about 1 wave/cm at wavelengths of about 300 nanometers to 1600 nanometers.

24. The multi-layer optical article of claim 21, wherein the multi-layer optical article has a bow of approximately 10⁻² or less.

25. The multi-layer optical article of claim 21, wherein the multi-layer optical article has a bow of approximately 10⁻⁵ or less.

26. The multi-layer optical article of claim 21, wherein the multi-layer article has a Strehl value of 0.9 or greater.

27. An apparatus for forming a multi-layer optical article, comprising:
a first holder and a second holder;
at least one spacer element, wherein the at least one spacer element is operable to be positioned between the first and second holder.

28. The apparatus of claim 27, wherein one of the first and second holders are movable along an axis, and one of the first and second holders is hinged for movement relative to the motion along the axis.

29. The apparatus of claim 27, wherein the spacer element is positioned between opposing surfaces of the first and second holders.

30. The apparatus of claim 27, wherein the opposing surfaces are operable to face each other at a selected angular relationship when in contact with the spacer element.

31. The apparatus of claim 30, wherein the angular relationship is parallel.

32. The apparatus of claim 27, wherein the spacer element is positioned by a mechanical mount between first and second holders.

33. The apparatus of claim 27, wherein the first and second holders are operable to grasp substrates.

34. The apparatus of claim 27, wherein the at least one spacer element includes a spacer ball.

35. The apparatus of claim 27, wherein the at least one spacer element includes a spacer ring.

36. The apparatus of claim 27, wherein the at least one spacer element includes a static mount.

37. The apparatus of claim 27, wherein the at least one spacer element is positioned by a mechanical mount.
